(19) United States
(12) Patent Application Publication
(10) Pub. No.: US 2013/0054409 A1
(43) Pub. Date: Feb. 28, 2013

(54) IN-APPLICATION PURCHASING METHOD AND METHOD FOR PROCESSING IN-APPLICATION PURCHASE

(71) Applicants: Young-Jin LEE, Daejeon (KR); Seog-Cheon JEON, Seoul (KR); Min KIM, Seoul (KR)

(72) Inventors: Young-Jin LEE, Daejeon (KR); Seog-Cheon JEON, Seoul (KR); Min KIM, Seoul (KR)

(73) Assignee: KT CORPORATION, Seongnam-city (KR)

(21) Appl. No.: 13/594,110

(22) Filed: Aug. 24, 2012

(30) Foreign Application Priority Data
Aug. 24, 2011 (KR) 10-2011-0084613

(51) Int. Cl. G06Q 30/06

(52) U.S. Cl. 705/26.8

(57) ABSTRACT

An in-application purchase processing method by a purchase processing server. The method includes: receiving a purchase request message of digital goods related to applications from a terminal; transmitting billing results of the digital goods to the terminal; receiving a download approval request message from the terminal; generating an authentication key for download approval and transmitting the authentication key to the terminal; receiving a download request message of the digital goods including the authentication key from the terminal; and transmitting a execution file of the digital goods in the application to the terminal.

### CROSS-REFERENCE TO RELATED APPLICATION

This application claims priority from Korean Patent Application No. 10-2011-0084613 filed in the Korean Intellectual Property Office on Aug. 24, 2011, the entire contents of which are incorporated herein by reference.

### BACKGROUND

(a) Field

Methods consistent with exemplary embodiments relate to an in-application purchasing method and an in-application purchase processing method.

(b) Description of the Related Art

An in-application payment or an in-application purchasing service, which is a service using pay contents after performing payment in an application, is referred to as a kind of partial pay service. For example, a developer distributes applications free and then, may require buying digital goods through the in-application payment so that the user may use additional functions of applications.

The partial pay service mainly applies to an on-line game service and may provide various types of contents such as electronic books, magazines, pictures, digital songs, or the like, with the distribution of a smart phone and the expansion of mobile applications. However, a conventional in-application payment method is a built-in method. The built-in method activates corresponding goods with respect to previously install goods such as items, or the like, which may be purchased in applications and then the users are allowed to use the installed items when the users purchase the goods. That is, the built-in method operates with respect to the previously installed goods by receiving only information regarding whether the goods are activated rather than downloading the purchased goods from a server. Therefore, the conventional built-in method needs to distribute pay goods by being previously included them in applications and it is not easy to add digital items after the development of the application, which results in insufficient extensibility of applications.

The above information disclosed in this Background section is only for enhancement of understanding of the background and therefore it may contain information that does not form the prior art that is already known in this country to a person of ordinary skill in the art.

### SUMMARY

Exemplary embodiments have been made in an effort to provide an in-application purchase method capable of directly providing a binary of purchased goods to a terminal at the time of in-application purchase and an in-application purchase processing method.

An exemplary embodiment provides a purchase processing method by a purchase processing server, including: receiving a purchase request message of digital goods executed in an application from a terminal; transmitting billing results of the digital goods to the terminal; receiving a download approval request message from the terminal; generating an authentication key for download approval and transmitting the generated authentication key to the terminal; receiving a download request message of the digital goods including the authentication key from the terminal; and transmitting the digital goods to the terminal.

The transmitting of the billing results of the digital goods may comprise:

mapping billing codes of the digital goods; inspecting whether the purchase request of the digital goods is valid; and transmitting billing processed results to the terminal based on the billing codes. In the transmitting of the digital goods, an executable file executing the digital goods in the application may be transmitted.

Another exemplary embodiment provides a method for purchasing by a terminal, comprising: displaying selling goods in the application and receiving digital goods selected from the displayed goods; transmitting a purchase request message of the digital goods to a purchasing processing server; receiving an authentication key for download approval from the purchase processing server; transmitting the download request message of the digital goods including the authentication key to the purchase processing server; and receiving an executable file of the digital goods from the purchase processing server.

The receiving of the authentication key may include: transmitting a download approval request message to the purchase processing server; and receiving the authentication key for download approval from the purchase processing server.

The method may further include: receiving billing results of the digital goods from the purchase processing server.

The method may further include: installing the executable file to execute the digital goods in the application.

Yet another exemplary embodiment provides a purchase processing method by a purchase processing server interworking with a download server transmitting digital goods, the method comprising: receiving a purchase request message of the digital goods associated with the application from a terminal; transmitting billing results of the digital goods to the terminal; receiving a download approval request message from the terminal; generating an authentication key for download approval and transmitting the generated authentication key to the terminal; receiving a download authentication request message of the digital goods from the download server; and generating download authentication results by comparing the authentication key transmitted to the terminal with the authentication key included in the download authentication request message and transmitting the download authentication results to the download server.

The download authentication request message may include the authentication key transmitted from the terminal.

The download server may be a device that transmits an executable file of the digital goods to the terminal according to the download authentication results.

Still another exemplary embodiment provides a method for purchasing by a terminal, comprising: displaying selling goods in the application and receiving digital goods selected from the displayed goods; transmitting a purchase request message of the digital goods to a purchase processing server; receiving an authentication key for download approval from the purchase processing server; transmitting the download request message of the digital goods including the authentication key to a download server; and receiving an executable file of the digital goods from the download server.

The download server may interwork with the purchase processing server to determine whether the digital goods are downloaded.

The receiving of the authentication key may comprise: transmitting a download approval request message to the purchase processing server; and receiving the authentication key for download approval from the purchase processing server.

The method may further include: receiving billing results of the digital goods from the purchase processing server.

According to another exemplary embodiment, there is provided a purchase processing server. The purchasing processing server comprises: a terminal interworking unit which receives a purchase request message of digital goods executed in an application from a terminal and a download approval request message, and which transmits billing results of the digital goods to the terminal; and an authentication key manager which generates an authentication key for download approval and transmits the generated authentication key to the terminal interworking unit, wherein the terminal interworking unit transmits the digital goods to the terminal.

The transmitting of the billing results of the digital goods may comprise: mapping billing codes of the digital goods; inspecting whether the purchase request of the digital goods is valid; and transmitting billing processed results to the terminal based on the billing codes.

A download server may interwork with the purchase processing server to determine whether the digital goods are downloaded.

According to another exemplary embodiment, it is possible to develop the application to which various digital items are applied by easily adding the digital items after the development of applications and increase the extensibility of applications by providing the developed applications to the user. Further, according to the exemplary embodiment, it is possible to provide various types of in-application purchase services and to allow the developers that do not provide the in-application purchase services to provide the in-application purchase services through the in-application purchase processing server.

### BRIEF DESCRIPTION OF THE DRAWINGS

FIG. 1 is a schematic diagram of an application purchase system according to an exemplary embodiment.

FIG. 2 is a flow chart of an in-application purchase processing method according to an exemplary embodiment.

FIG. 3 is a flow chart of an in-application purchasing method according to an exemplary embodiment.

FIG. 4 is a flow chart of an in-application purchase processing method according to another exemplary embodiment.

FIG. 5 is a flow chart of an in-application purchase processing method according to another exemplary embodiment.

FIG. 6 is a flow chart of an in-application purchase method between a terminal and a purchase processing server according to an exemplary embodiment.

FIG. 7 is a flow chart of an in-application purchase method between a terminal and a purchase processing server according to another exemplary embodiment.

FIG. 8 is a block diagram of a purchase processing server according to an exemplary embodiment.

FIG. 9 is a block diagram of a terminal according to an exemplary embodiment.

### DETAILED DESCRIPTION OF EXEMPLARY EMBODIMENTS

In the following detailed description, only certain exemplary embodiments have been shown and described, simply by way of illustration. As those skilled in the art would realize, the described exemplary embodiments may be modified in various different ways, all without departing from the spirit or scope of the present inventive concept. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

Hereinafter, an in-application purchasing method and an in-application purchase processing method according to exemplary embodiments will be described below in detail with reference to the accompanying drawings.

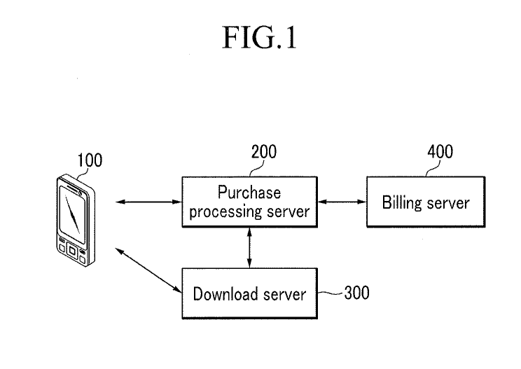

FIG. 1 is a schematic diagram of an application purchase system according to an exemplary embodiment.

Referring to FIG. 1, an application purchase system includes a terminal 100, a purchase processing server 200, a download server 300, and a billing server 400.

The terminal 100 downloads and installs an application and executes the application to use services provided by the application. In this case, the application is a kind of a program block including contents that may be used in the terminal 100 and may be installed in the terminal 100 in plural. The terminal 100 purchases digital goods executed in the application by performing payment in the application. That is, the terminal 100 displays the goods sold for the application in the application, and allows users to select the digital goods in the application. As described above, purchasing goods in the application is referred to as in-application purchasing or in-application payment, or a partial pay scheme.

The purchase processing server 200 interworks with the billing server 400 to manage billing processing of the digital goods that receive a purchase request by the terminal 100. Further, the purchase processing server 200 may directly transmit an executable file that executes the digital goods to the terminal 100, when the purchase processing server 200 stores and manages the digital goods by itself. Alternatively, the purchase processing server 200 interworks with the external download server 300 which transmits the executable file of the digital goods to the terminal 100, instead of transmitting the executable file directly.

The download server 300 interworks with the purchase processing server 200 when receiving the download request of the digital goods from the terminal 100. The download server 300 transmits the digital goods purchased in the application to the terminal 100. The download server 300 stores various types of information capable of updating the application. For example, the download server 300 stores the goods information sold in the application made by the developer developing the application, and transmits the digital goods according to download authentication results when the purchase processing server 200 transmits the authentication results for the download request of the terminal 100. Therefore, the application developers do not need to build the purchase processing server and the billing server for in-application purchasing services. They simply interwork with the purchase processing server 200 to provide the in-application purchasing services to the application users.

The billing server 400 allows the purchase processing server 200 to perform the billing processing based on billing codes mapped to the digital goods. Further, the billing server 400 transmits the billing process results to the purchase processing server 200.

The built-in method that is a type of in-application purchasing method develops the application including the digital goods in advance. And then, the server transmits the goods activation message to the terminal when the digital goods included in the application are purchased, which the goods activation message activates the digital goods previously included in the application.

On the other hand, the purchase processing server 200 transmits the executable file of the purchased digital goods when generating the purchase request in the application. Therefore, the purchase processing server 200 may easily add new digital goods that are not included in the application at the time of development because the substantive executable file instead of the activation message is transmitted to the terminal 100. Therefore, the purchase processing server 200 can add the digital goods after the application is developed, thereby continuously extending the application. Further, because the purchase processing server 200 performs the download authentication based on an authentication key and transmits the result to the download server 300, the download server 300 may provide the in-application purchase service without building a system for the billing and purchase function separately.

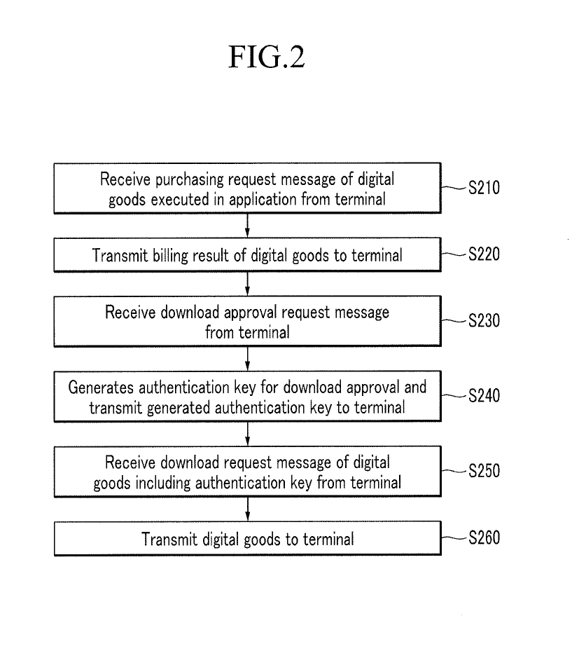

FIG. 2 is a flow chart of an in-application purchase processing method according to an exemplary embodiment.

Referring to FIG. 2, the purchase processing server 200 stores the digital goods and transmits the stored digital goods to the terminal 100 when there is a purchase request of the corresponding digital goods from the terminal 100.

The purchase processing server 200 receives the purchase request message of the digital goods executed in the application from the terminal 100 (S210). The purchase processing server 200 may communicate with a terminal client mounted in the terminal 100. The terminal client may interwork with the application to transmit the information input from the application to the purchase processing server 200 or receive the digital goods so as to be installed and executed in the application.

The purchase processing server 200 transmits the billing results of the digital goods to the terminal 100 (S220). In this case, the purchase processing server 200 maps the billing codes of the digital goods. Further, the purchase processing server 200 may inspect whether the purchase request of the digital goods is valid. For example, the purchase processing server 200 inspects whether to exceed the billing upper bound or checks the number of the purchase times, to prevent the duplicate purchase and misuse. The purchase processing server 200 requests the billing processing from the billing server 400 based on the billing code for the valid purchase request. The purchase processing server 200 receives the billing processed results from the billing server 400 and transmits the received results to the terminal 100. Further, the purchase processing server 200 stores various types of purchase related information, for example, a billing history or a purchase history.

The purchase processing server 200 receives the download approval request message from the terminal 100 (S230).

The purchase processing server 200 generates the authentication key for download approval and transmits the generated authentication key to the terminal 100 (S240).

The purchase processing server 200 receives the download request message of the digital goods including the authentication key from the terminal 100 (S250).

The purchase processing server 200 transmits the digital goods to the terminal 100 (S260). The purchase processing server 200 may transmit the executable file executing the digital goods in the application, wherein the executable file may be, for example, the binary file. In this case, the purchase processing server 200 compares the authentication key transmitted to the terminal 100 and the authentication key included in the download request message received from the terminal 100 to determine whether to transmit the executable file of the digital goods.

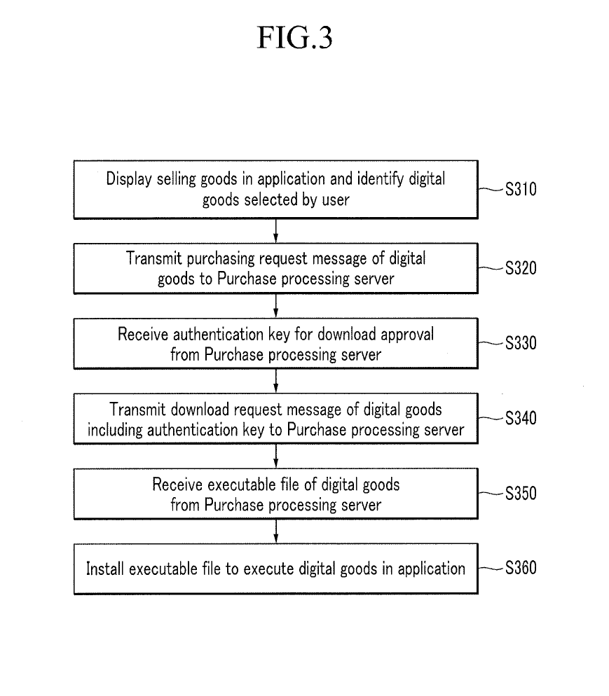

FIG. 3 is a flow chart of an in-application purchase method according to an exemplary embodiment.

Referring to FIG. 3, the terminal 100 displays the selling goods in the application and identifies the digital goods selected by user (S310). The terminal 100 may communicate with the purchase processing server 200 through a mounted terminal client.

The terminal 100 transmits the purchase request message of the digital goods to the purchase processing server 200 (S320).

The terminal 100 receives the authentication key for download approval from the purchase processing server 200 (S330). In this case, the terminal 100 may transmit the download approval request message to the purchase processing server 200, and then receive the authentication key issued by the purchase processing server 200. The terminal 100 may be issued with the authentication key when the billing processing of the purchased digital goods is completed. In addition, the terminal 100 may receive the billing results of the digital goods from the purchase processing server 200.

The terminal 100 transmits the download request message of the digital goods including the authentication key to the purchase processing server 200 (S340).

The terminal 100 receives the executable file of the digital goods from the purchase processing server 200 (S350). I

The terminal 100 executes the digital goods in the application by installing the executable file (S360).

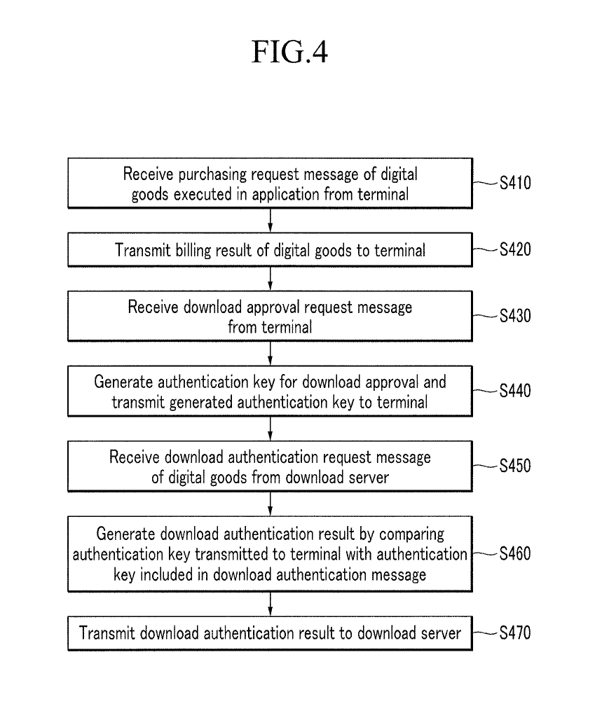

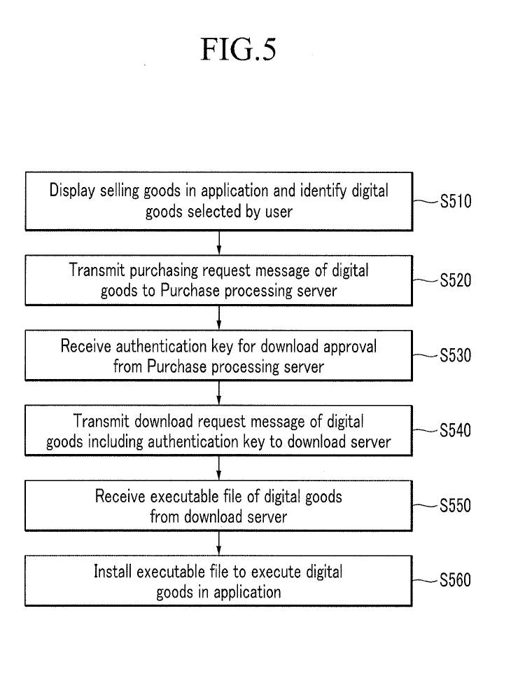

FIG. 4 is a flow chart of an in-application purchase processing method according to another exemplary embodiment and FIG. 5 is a flow chart of an in-application purchase processing method according to another exemplary embodiment.

Referring first to FIG. 4, the purchase processing server 200 allows the external download server 300 storing the digital goods to transmit the digital goods to the terminal 100 instead of directly transmitting the digital goods in connection with the digital goods that are not stored, thereby processing the in-application purchase. To this end, the purchase processing server 200 transmits the download authentication results that are a kind of a download authority of terminal 100 to the download server 300.

The purchase processing server 200 receives the purchase request message of the digital goods associated with the application from the terminal 100 (S410).

The purchase processing server 200 transmits the billing results of the digital goods to the terminal 100 (S420). In this case, the purchase processing server 200 maps the billing codes of the digital goods. Further, the purchase processing server 200 may inspect whether the purchase request of the digital goods is valid. For example, the purchase processing server 200 inspects whether to exceed the billing upper limit or checks the number of the purchase times, to prevent duplicate purchase and misuse. The purchase processing server 200 requests the billing processing from the billing server 400 based on the billing code for the valid purchase request. The purchase processing server 200 receives the billing processed results from the billing server 400 and transmits the received results to the terminal 100. In addition, the purchase processing server 200 stores various types of purchase related information, for example, a billing history or a purchase history.

The purchase processing server 200 receives the download approval request message from the terminal 100 (S430).

The purchase processing server 200 generates the authentication key for download approval and transmits the generated authentication key to the terminal 100 (S440).

The purchase processing server 200 receives the download authentication request message of the digital goods from the download server 300 (S450). The download server 300 transmits the download authentication request message, including the authentication key transmitted from the terminal 100.

The purchase processing server 200 compares the authentication key transmitted to the terminal 100 with the authentication key included in the download authentication message to generate the download authentication results (S460).

The purchase processing server 200 transmits the download authentication results to the download server 300 (S470). The download server 300 transmits the executable file of the digital goods to the terminal 100 according to the download authentication results. The download server 300 may transmit the binary file executing the digital goods in the application.

Next, referring to FIG. 5, the terminal 100 displays the selling goods in the application and identifies the digital goods selected by user (S510). The terminal 100 may communicate with the purchase processing server 200 through the mounted terminal client.

The terminal 100 transmits the purchase request message of the digital goods to the purchase processing server 200 (S520).

The terminal 100 receives the authentication key for download approval from the purchase processing server 200 (S530). In this case, the terminal 100 may transmit the download approval request message to the purchase processing server 200, and then receive the authentication key issued by the purchase processing server 200. The terminal 100 may be issued with the authentication key when the billing processing of the purchased digital goods is completed. In addition, the terminal 100 may receive the billing results of the digital goods from the purchase processing server 200.

The terminal 100 transmits the download request message of the digital goods including the authentication key to the download server 300 (S540).

The terminal 100 receives the executable file of the digital goods from the download server 300 (S550). The download server 300 interworks with the purchase processing server 200 to determine whether the digital goods are downloaded, thereby transmitting the executable file of the digital goods.

The terminal 100 executes the digital goods in the application by installing the executable file (S560).

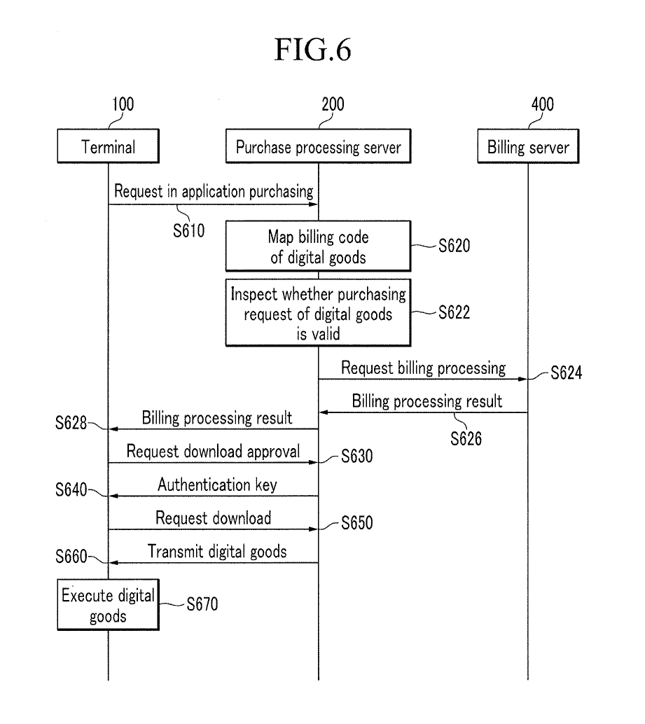

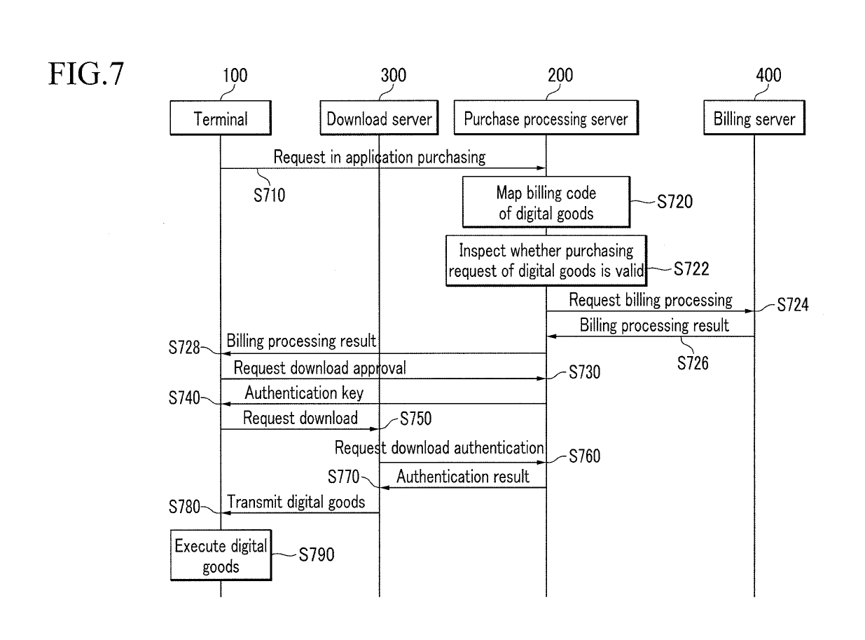

FIG. 6 is a flow chart of an in-application purchase method between a terminal and a purchase processing server according to an exemplary embodiment and FIG. 7 is a flow chart of an in-application purchase method between a terminal and a purchase processing server according to another exemplary embodiment.

Referring first to FIG. 6, the terminal 100 requests the purchase of the digital goods selected in the application (S610).

The purchase processing server 200 maps the billing codes of the digital goods (S620).

The purchase processing server 200 inspects whether the purchase request of the digital goods is valid (S622).

The purchase processing server 200 requests billing processing from the billing server 400 based on the billing code (S624).

The purchase processing server 200 receives the billing processed results from the billing server 400 (S626).

The purchase processing server 200 transmits the billing processed results to the terminal 100 (S628).

The terminal 100 requests the download approval from the purchase processing server 200 (S630).

The purchase processing server 200 generates the authentication key for download approval and transmits the generated authentication key to the terminal 100 (S640).

The terminal 100 requests the download of the digital goods from the purchase processing server 200 (S650). In this case, the terminal 100 requests the download, including the authentication key. In this case, when the purchase processing server 200 stores and manages the corresponding digital goods, the terminal 100 requests the download of the digital goods from the purchase processing server 200.

The purchase processing server 200 confirms the authentication key and then, transmits the digital goods to the terminal 100 (S660). In this case, the digital goods may be an executable file that may execute the digital goods in the application.

The terminal 100 executes the digital goods in the application by installing the executable file (S670).

Referring to FIG. 7, the terminal 100 requests the purchase of the digital goods selected in the application (S710).

The purchase processing server 200 maps the billing codes of the digital goods (S720).

The purchase processing server 200 inspects whether the purchase request of the digital goods is valid (S722).

The purchase processing server 200 requests billing processing from the billing server 400 based on the billing code (S724).

The purchase processing server 200 receives the billing processed results from the billing server 400 (S726).

The purchase processed server 200 transmits the billing processed results to the terminal 100 (S728).

The terminal 100 requests the download approval from the purchase processing server 200 (S730).

The purchase processing server 200 generates the authentication key for download approval and transmits the generated authentication key to the terminal 100 (S740).

The terminal 100 requests download of the digital goods from the download server 300 (S750). In this case, the terminal 100 requests the download, including the authentication key. That is, when the digital goods purchased by the terminal 100 are stored in the download server 300 rather than in the purchase processing server 200, the terminal 100 requests the download of the digital goods from the download server 300.

The download server 300 requests the download authentication to the purchase processing server 200 (S760). In this case, the download server 300 requests the download authentication, including the authentication key transmitted from the terminal 100.

The purchase processing server 200 transmits the download authentication results generated by confirming the authentication key to the download server 300 (S770). The purchase processing server 200 compares the authentication key transmitted to the terminal 100 with the authentication key received from the download server 300.

The download server 300 transmits the digital goods to the terminal 100 based on the download authentication results (S780). In this case, the digital goods may be an executable file that may execute the digital goods in the application.

The terminal 100 executes the digital goods in the application by installing the executable file (S790).

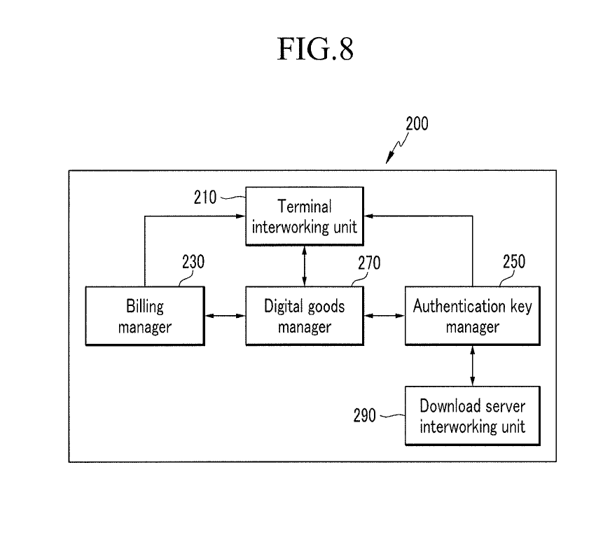

FIG. 8 is a block diagram of a purchase processing server according to an exemplary embodiment.

Referring to FIG. 8, the purchase processing server 200 includes a terminal interworking unit 210, a billing manager 230, an authentication key manage 250, a digital goods manager 270, and a download server interworking unit 290.

The terminal interworking unit 210 interworks with the terminal 100 to exchange various types of messages. The terminal interworking unit 210 receives the purchase request message of the digital goods, the download approval request message, the download request message, or the like from the terminal 100. Further, the terminal interworking unit 210 transmits the billing result of the digital goods processed at the billing manager 230, the authentication key generated at the authentication key manager 250, and the digital goods stored in the digital goods manager 270 to the terminal 100. The terminal interworking unit 210 may be implemented by software, hardware, or a combination of hardware and software.

The billing manager 230 maps the billing codes of the digital goods and inspects whether the purchase request of the digital goods is valid. Further, the purchase billing manager 230 interworks with the billing server 400 to acquire the billing processed results. In addition, the billing manager 230 stores various types of purchase related information, for example, a billing history or a purchase history.

The authentication key manager 250 generates the authentication key transmitted when the terminal 100 requests the download. The authentication manager 250 transmits the authentication key to the terminal interworking unit 210. Further, the authentication key manager 250 confirms whether the authentication key transmitted from the terminal 100 is the authentication key issued by the authentication key manager 250 and determines whether the authentication key is the valid authentication key. In addition, the authentication key manager 250 confirms whether the authentication key requesting the download authentication by the download server 300 is the authentication key issued by the authentication key manager 250 and determines whether the authentication key is the valid authentication key.

The digital goods manager 270 stores and manages the digital goods. The digital goods manager 270 interworks with the billing manager 230 to process the billing when the purchase of the digital goods is requested from the terminal 100. The digital goods manager 270 interworks with the authentication key manager 250 to generate the authentication key when the download approval is requested. The digital goods manager 270 transmits the stored digital goods to the terminal 100 that transmits the valid authentication key when the download is requested from the terminal 100. The digital goods manager 270 transmits the substantive executable file, wherein the executable file may be the binary file.

The download server interworking unit 290 interworks with the download server 300 to provide determination information necessary to transmit the digital goods from the download server 300. The download server interworking unit 290 receives the download authentication request message of the digital goods from the download server 300 and the download server 300 compares the received download authentication request message with the authentication key to transmit the download authentication results.

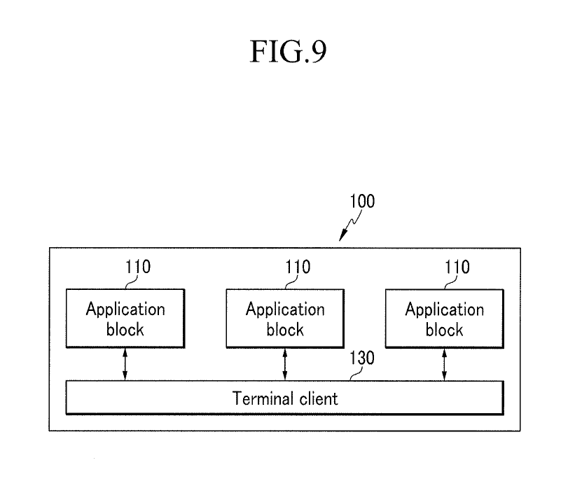

FIG. 9 is a block diagram of a terminal according to an exemplary embodiment.

Referring to FIG. 9, the terminal 100 includes an application block 110 and a terminal client 130.

The application block 110, which is a block in which the application is executed, is a kind of a program block. The application blocks 110 may be installed in the terminal 100 in plural.

The terminal client 130 communicates with the purchase processing server 200 or the download server 300 for the in-application purchase when the digital goods to be purchased are selected in the application block 110. The terminal client 130 receives the authentication key for download approval from the purchase processing server 200. Further, the terminal client 130 transmits the download request message to the purchase processing server 200 or the download server 300 and downloads the digital goods purchased from the purchase processing server 200 or the download server 300. The terminal client 130 updates the application with the downloaded digital goods.

As described above, according to the exemplary embodiment, the application developers can easily add the digital items after the development of the application and can develop the application to which various digital items are applied. Further, according to the exemplary embodiment, an application seller may provide various types of the in-application purchase services. In addition, the application developers that do not employ the in-application purchasing system autonomously may provide the in-application purchasing services through the purchase processing server 200.

While exemplary embodiments have been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A purchase processing method by a purchase processing server, the method comprising:
receiving a purchase request message of digital goods executed in an application from a terminal;
transmitting billing results of the digital goods to the terminal;
receiving a download approval request message from the terminal;
generating an authentication key for download approval and transmitting the authentication key to the terminal;
receiving a download request message of the digital goods including the authentication key from the terminal; and
transmitting the digital goods to the terminal.

2. The method of claim 1, wherein:
the transmitting of the billing results of the digital goods comprises:
mapping billing codes of the digital goods;
inspecting whether the purchase request of the digital goods is valid; and
transmitting billing processed results to the terminal based on the billing codes.

3. The method of claim 1, wherein:
the transmitting of the digital goods comprises
transmitting an executable file for executing the digital goods in the application.

4. A method for purchase by a terminal, the method comprising:
displaying selling goods in an application and identifying digital goods selected from the displayed goods;
transmitting a purchase request message of the digital goods to a purchase processing server;
receiving an authentication key for download approval from the purchase processing server;
transmitting a download request message of the digital goods including the authentication key to the purchase processing server; and
receiving an executable file of the digital goods from the purchase processing server.

5. The method of claim 4, wherein:
the receiving of the authentication key comprises:
transmitting a download approval request message to the purchase processing server; and
receiving the authentication key for download approval from the purchase processing server.

6. The method of claim 4, further comprising:
receiving billing results of the digital goods from the purchase processing server.

7. The method of claim 4, further comprising:
installing the executable file to execute the digital goods in the application.

8. A purchase processing method by a purchase processing server interworking with a download server transmitting digital goods, the method comprising:
receiving a purchase request message of the digital goods associated with an application from a terminal;
transmitting billing results of the digital goods to the terminal;
receiving a download approval request message from the terminal;
generating an authentication key for download approval and transmitting the authentication key to the terminal;
receiving a download authentication request message of the digital goods from the download server; and
generating download authentication results by comparing the authentication key transmitted to the terminal with an authentication key included in the download authentication request message and transmitting the download authentication results to the download server.

9. The method of claim 8, wherein:
the authentication key included in the download authentication request message is transmitted from the terminal.

10. The method of claim 8, wherein:
the download server is a device that transmits an executable file of the digital goods to the terminal according to the download authentication results.

11. A method for purchasing by a terminal, the method comprising:
displaying selling goods in an application and identifying digital goods selected from the displayed goods;
transmitting a purchase request message of the digital goods to a purchase processing server;
receiving an authentication key for download approval from the purchase processing server;
transmitting a download request message of the digital goods including the authentication key to a download server; and
receiving an executable file of the digital goods from the download server.

12. The method of claim 11, wherein:
the download server interworks with the purchase processing server to determine whether the digital goods are downloaded.

13. The method of claim 11, wherein:
the receiving of the authentication key comprises:
transmitting a download approval request message to the purchase processing server; and
receiving the authentication key for download approval from the purchase processing server.

14. The method of claim 11, further comprising:
receiving billing results of the digital goods from the purchase processing server.

15. A purchase processing server, comprising:
a terminal interworking unit which receives a purchase request message of digital goods executed in an application from a terminal and a download approval request message, and which transmits billing results of the digital goods to the terminal; and
an authentication key manager which generates an authentication key for download approval and transmits the generated authentication key to the terminal interworking unit,
wherein the terminal interworking unit transmits the digital goods to the terminal.

16. The purchase processing server of claim 15, wherein:
the transmitting of the billing results of the digital goods comprises:
mapping billing codes of the digital goods;
inspecting whether the purchase request of the digital goods is valid; and
transmitting billing processed results to the terminal based on the billing codes.

17. The purchase processing server of claim 15, wherein:
a download server interworks with the purchase processing server to determine whether the digital goods are downloaded.
